(19) United States
(12) Patent Application Publication
(10) Pub. No.: US 2015/0142511 A1
(43) Pub. Date: May 21, 2015

(54) RECOMMENDING AND PRICING DATASETS

(71) Applicant: International Business Machines Corporation, Armonk, NY (US)

(72) Inventors: Aris Gkoulalas-Divanis, Dublin (IE); Michael Wurst, Stuttgart (DE)

(21) Appl. No.: 14/313,312

(22) Filed: Jun. 24, 2014

Related U.S. Application Data
(63) Continuation of application No. 14/086,180, filed on Nov. 21, 2013.

(51) Int. Cl. G06Q 30/02; G06N 99/00

(52) U.S. Cl. CPC G06Q 30/0201; G06N 99/005; G06Q 30/0206
USPC 705/7.29

(57) ABSTRACT

A computer processor provides a set of datasets, including at least a first dataset, with each dataset of the set of datasets respectively being configured to allow the dataset to be presented according to multiple variations, with each variation being defined by a selection of at least one transformation. The computer processor receives customer feedback information relating to at least a first variation of the first dataset. The computer processor trains a first machine learning algorithm, based, at least in part, upon the customer feedback information. The computer processor performs, by the first machine learning algorithm, a marketing act. The marketing act includes at least one of the following: (i) defining a new variation of the first dataset, (ii) defining a new transformation for defining variations of the first dataset, (iii) recommending a predefined variation of the first dataset, and (iv) pricing a predefined variation of the first dataset.

### FIELD OF THE INVENTION

The present invention relates generally to the field of machine learning, and also to recommending and pricing datasets.

### BACKGROUND OF THE INVENTION

Machine learning, a branch of artificial intelligence, concerns the construction and study of systems that can learn from data. For example, a machine learning system could be trained on email messages to learn to distinguish between spam and non-spam messages. After learning, the machine learning system can then be used to classify new email messages into spam and non-spam folders.

One conventional example of a machine learning algorithm is a naïve Bayes classifier, which is based on applying Bayes' theorem with strong (naïve) independence assumptions. A naïve Bayes classifier assumes that the presence or absence of a particular feature is unrelated to the presence or absence of any other feature, given the class variable.

### SUMMARY

Embodiments of the present invention disclose a method, computer program product, and system in which a computer processor provides a set of datasets, including at least a first dataset, with each dataset of the set of datasets respectively being configured to allow the dataset to be presented according to multiple variations, with each variation being defined by a selection of at least one transformation. The computer processor receives customer feedback information relating to at least a first variation of the first dataset. The computer processor trains a first machine learning algorithm, based, at least in part, upon the customer feedback information. The computer processor performs, by the first machine learning algorithm, a marketing act. The marketing act includes at least one of the following: (i) defining a new variation of the first dataset, (ii) defining a new transformation for defining variations of the first dataset, (iii) recommending a predefined variation of the first dataset, and (iv) pricing a predefined variation of the first dataset.

### BRIEF DESCRIPTION OF THE SEVERAL VIEWS OF THE DRAWINGS

FIG. 1 is a functional block diagram illustrating a data processing environment, in accordance with an embodiment of the present invention.

FIG. 2 is a flowchart depicting operational steps of a vendor program for recommending and pricing a variation of a dataset, in accordance with an embodiment of the present invention.

FIG. 3 is a flowchart depicting operational steps of an aspect of the vendor program, in accordance with an embodiment of the present invention.

FIG. 4 depicts a block diagram of components of the computer system executing the vendor program, in accordance with an embodiment of the present invention.

### DETAILED DESCRIPTION

Embodiments of the present invention recognize that: (i) sets of electronically stored data (herein called “datasets”) can be bought and sold; (ii) datasets may relate to, to name just a few examples, meteorological data, demographic data, survey results, sales figures, or customer purchases; (iii) datasets may differ in scope, level of detail, quality, scope of coverage, etc.; (iv) a given dataset may be organized into one of many different variations, each variation having different characteristics and possibly a different market value; (v) content-based methods of price determination analyze the properties of a product and model the preferences of a customer by creating an interest profile; (vi) content-based methods may be inapplicable to the purchase and sale of datasets; and (vii) a dataset variation (a “variation” refers to a version of a dataset where at least one “transformation” is applied to the dataset) may be less valuable to a given customer if it is highly similar to a dataset already owned by the customer.

Some embodiments of the present invention may include one, or more, of the following features, characteristics and/or advantages: (i) a mechanism for recommending a dataset based, at least in part, on a customer purchase history; (ii) a mechanism for determining a price for the dataset based, at least in part, on a customer purchase history; (iii) a mechanism for determining “modifiers” for a dataset based, at least in part, on the customer purchase history; (iv) a mechanism for recommending existing “modifiers” for a dataset based, at least in part, on the customer purchase history; and/or (v) a mechanism for pricing “modifiers” for a dataset based, at least in part, on the customer purchase history.

More broadly, some embodiments of the present invention train machine learning algorithms based upon customer feedback information, which is hereby defined as any information received back from a customer, or potential customer, of a dataset. Some examples of customer feedback information include (without limitation): (i) a price that a customer, or potential customer, has paid, or offered to pay, for a dataset variation; (ii) an evaluation of a dataset variation by a customer or potential customer; and/or (iii) speculative comments, by a customer, or potential customer, relating to a dataset variation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, or semiconductor system, apparatus, or device, or any suitable combination of the foregoing. More specific examples (a non-exhaustive list) of a computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. The term “computer-readable storage media” does not include computer-readable signal media.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java is a registered trademark of Oracle in the United States, other countries, or both), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

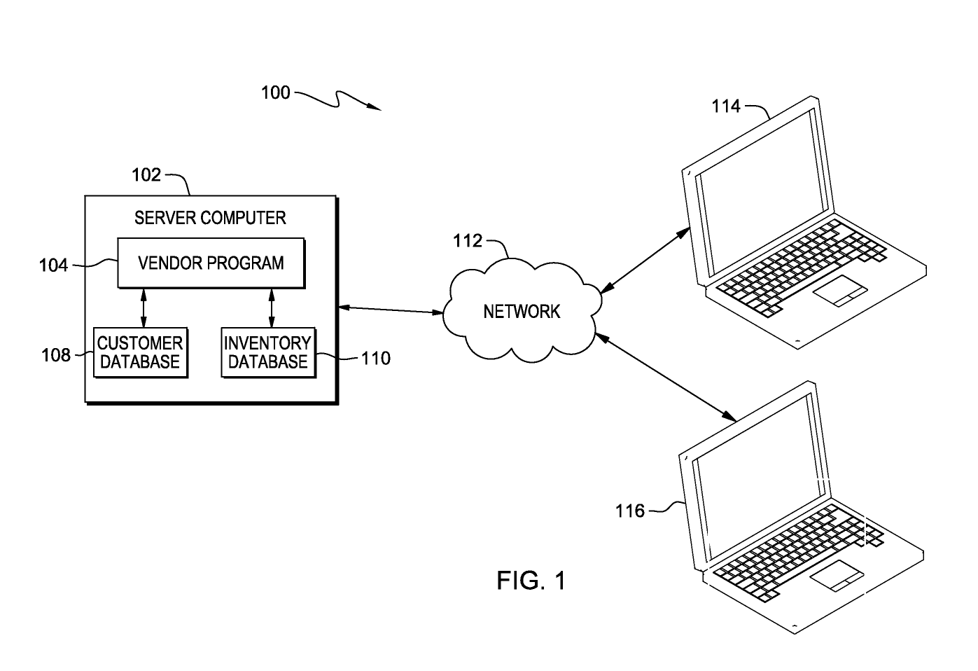

FIG. 1 is a functional block diagram illustrating a data processing environment, generally designated 100, in accordance with one embodiment of the present invention.

Data processing environment 100 includes server computer 102 and client devices 114 and 116, all interconnected over network 112.

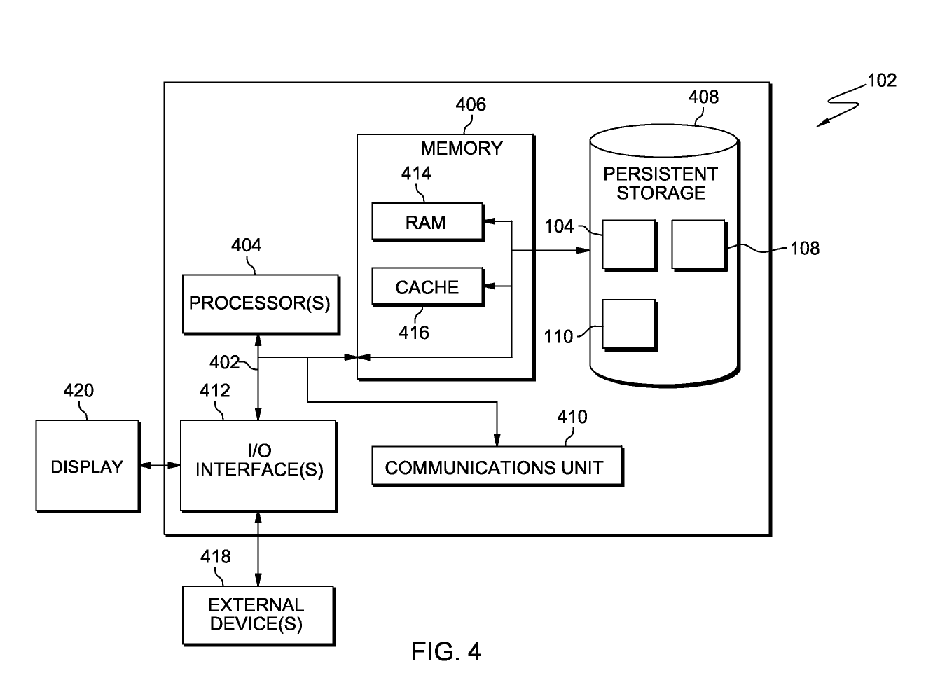

Server computer 102, client device 114, and client device 116 can each respectively be a laptop computer, a tablet computer, a netbook computer, a personal computer (PC), a desktop computer, a personal digital assistant (PDA), a smart phone, or any programmable electronic device capable of communicating with each other via network 112. In other embodiments, server computer 102 may represent a server computing system utilizing multiple computers as a server system, such as in a cloud computing environment. Server computer 102 includes vendor program 104, customer database 108, and inventory database 110. Server computer 102 may include internal and external hardware components, as depicted and described in further detail with respect to FIG. 4.

Network 112 can be, for example, a local area network (LAN), a wide area network (WAN) such as the Internet, or a combination of the two, and can include wired, wireless, or fiber optic connections. In general, network 112 can be any combination of connections and protocols that will support communications between server computer 102 and client devices 114 and 116.

Vendor program 104 operates, in part, to select a dataset, select one or more modifiers, and perform a marketing act. In various embodiments, the marketing act can be to modify the dataset with the modifier, to determine a modified dataset (a “variation”), to recommend a variation, to price a variation of the first dataset, or any combination thereof. A dataset is a collection of data. A modifier is an operation that can be performed on a dataset to alter a characteristic of the dataset. Applying a modifier can, for example, select a subset of attributes of a dataset, select a subset of records of a dataset, add noise data to a dataset, or reduce the precision of an attribute. An original dataset is the dataset to which one or more modifiers are applied in order to generate the variation. A modifier is applied to the original dataset to produce a variation. In one embodiment, modifiers are commutative, meaning that applying a plurality of modifiers produces the same variation regardless of the order in which each of the plurality of modifiers is applied to the dataset.

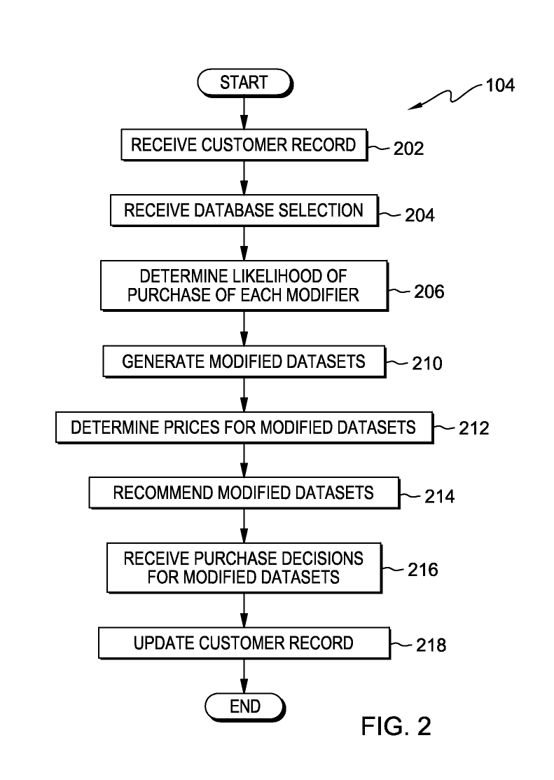

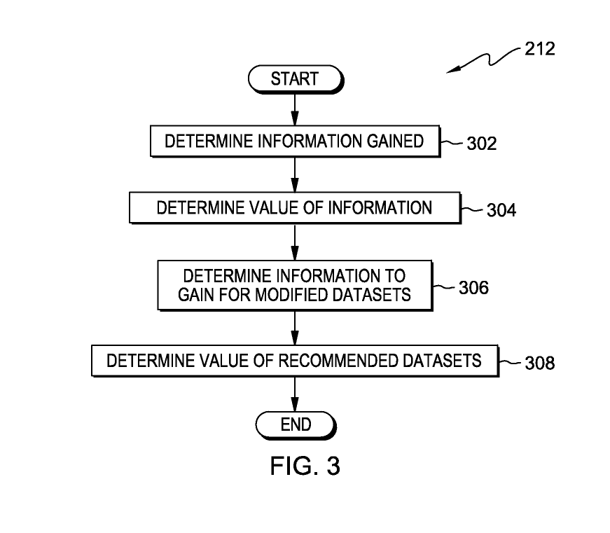

Vendor program 104 further operates to recommend variations based on customer records and to determine prices for the variations. In one embodiment, vendor program 104 recommends variations by presenting the recommended variations to a customer (e.g., via client device 114 or 116). In one embodiment, the datasets reside in inventory database 110 and the customer records reside in customer database 108. In one embodiment, vendor program 104 resides on server computer 102. In other embodiments, vendor program 104 may reside on another server computer or another computing device, provided that vendor program 104 is in communication with client devices 114 and 116, customer database 108, and inventory database 110. Vendor program 104 is discussed in greater detail in connection with FIGS. 2 and 3.

Customer database 108 operates to store customer records pertaining to at least one customer, such as a customer utilizing client device 114 or 116. In one embodiment, customer database 108 resides on server computer 102. In other embodiments, customer database 108 may reside on another server computer or another computing device, provided that customer database 108 is in communication with at least vendor program 104.

Customer database 108 may be a database, such as a relational database, which stores a customer record corresponding to a customer. In one embodiment, the customer record comprises a purchase history, which identifies one or more datasets previously presented to the customer, each of which is associated with a purchase decision, a price, and a time of presentation. The purchase decision indicates whether the customer purchased the presented dataset when it was presented. The price indicates the price at which the presented dataset was presented to the customer. The time indicates the time at which the presented database was presented to the customer and may be, for example, a date, a date and time, or a visit number. The customer record may also identify one or more modifiers associated with each dataset, which indicates the modifiers applied to the dataset at the time of presentation to the customer. In one embodiment, a dataset or variation may be presented to a customer more than once, for example at two different times and/or at two different prices.

Inventory database 110 operates to store one or more datasets. In one embodiment, inventory database 110 resides on server computer 102. In other embodiments, inventory database 110 may reside on another server computer or another computing device, provided that inventory database 110 is in communication with at least vendor program 104.

Inventory database 110 may be a database, such as a relational database, which stores one or more datasets. A dataset is a collection of records, each of which contains a set of attributes. In various embodiments, each dataset contains data such as meteorological data, demographic data, survey result data, sales data, customer data, etc. In one embodiment, inventory database 110 categorizes stored datasets into categories. For example, a first and a second dataset of inventory database 110 may contain meteorological data for a first and a second region, respectively, in which case inventory database 110 categorizes the first and second datasets into a meteorological data category.

FIG. 2 is a flowchart depicting operational steps of vendor program 104 for recommending and pricing datasets, in accordance with an embodiment of the present invention.

In step 202, vendor program 104 receives a customer record. In one embodiment, the customer record comprises a purchase history identifying at least one dataset and corresponding purchase decision, price, time of presentation, and one or more modifiers.

In some embodiments, the purchase history of the customer record identifies no datasets, such as in the case of a first-time customer. In some embodiments, vendor program 104 receives the customer record from customer database 108. For example, vendor program 104 may retrieve the customer record from customer database 108 or vendor program 104 may query customer database 108 and, in response, receive the customer record.

In step 204, vendor program 104 receives a dataset selection identifying (i.e. selecting) a dataset. In one embodiment, the selected dataset is a dataset of inventory database 110. In one embodiment, vendor program 104 receives the dataset selection as user input from a client device (e.g., client device 114 or 116). For example, vendor program 104 may present one or more datasets to the client device (e.g., client device 114 or 116) and receive as user input a dataset selection identifying a selected dataset of the one or more datasets. In one such embodiment, vendor program 104 presents one or more databases based on the purchase history of the customer record. In another embodiment, vendor program 104 presents one or more databases based on the aggregate purchase history of customer records corresponding to one or more other customers.

In some embodiments, vendor program 104 receives the dataset selection by determining a dataset similar to at least one dataset of a customer record. For example, the selected dataset may correspond to a category which corresponds to at least one dataset of the customer record. In yet another embodiment, vendor program 104 receives the dataset selection by selecting a dataset of inventory database 110 at random.

In step 206, vendor program 104 analyzes a customer record to determine a likelihood of purchase for each available modifier. In one embodiment, vendor program 104 analyzes a customer record to determine a likelihood of purchase for combinations of available modifiers. In one embodiment, vendor program 104 compares the modifiers of each database identified by the purchase history of the customer record to the purchase decision corresponding to the database to determine a likelihood of purchase for each modifier.

In one embodiment, vendor program 104 utilizes probabilistic sampling to select for combinations of modifiers with the highest probably of purchase by the customer. In a simple example, a purchase history may identify purchased datasets having both a first and second modifier and non-purchased datasets having neither or only one of the first and second modifier. In this case, vendor program 104 may determine a high purchase probability for datasets having both the first and second modifiers and a low purchase probability for datasets having neither or only one of the first and second modifiers.

In some embodiments, vendor program 104 may analyze the customer record by correlating modifiers and datasets, for example utilizing an attribute-value system in which each dataset is labeled to indicate whether the dataset was purchased. An attribute-value system is a system of representing information including a table with columns designating attributes (e.g., transformation operations), rows designating objects (e.g., datasets), and cells designating values (e.g., whether a dataset is associated with a transformation operation).

In step 210, vendor program 104 generates at least one variation from the selected dataset. Vendor program 104 generates each variation by applying at least one modifier to the selected dataset. In one embodiment, vendor program 104 applies the modifier having the highest purchase probability, as determined in step 206.

In some embodiments, vendor program 104 generates a certain quantity of variations, which may be a pre-determined quantity or a quantity received as user input (e.g., from client device 114 or 116). In some embodiments, vendor program 104 generates all possible variations of the selected dataset, each generated with a different combination of modifiers. In some embodiments, vendor program 104 generates variations of the selected dataset using all transformation operations classified as high-value. In some embodiments, vendor program 104 generates variations using at least one transformation operation specified by user criteria. In some embodiments, vendor program 104 randomly selects and applies a modifier to a dataset to generate a variation. In some embodiments, vendor program 104 applies a plurality of modifiers.

In step 212, vendor program 104 determines a price for each variation generated in step 210. One embodiment of step 212 is discussed in more detail in connection with FIG. 3.

In step 214, vendor program 104 recommends the variations. In one embodiment, vendor program 104 recommends the variations by presenting the variations to a user (e.g., a customer) via a client device (e.g., client device 114 or 116).

In some embodiments, vendor program 104 receives a price value as user input. In one embodiment, the price value indicates a maximum price, in which case vendor program 104 recommends only those variations with a determined price at or below price value (i.e., the maximum price). In another embodiment, the price value indicates a minimum price, in which case vendor program 104 presents only those variations with a determined price at or above the price value (i.e., the minimum price).

In step 216, vendor program 104 receives purchase decisions for the recommended variations. In one embodiment, vendor program 104 receives the purchase decisions as user input from a client device (e.g., client device 114 or 116). Each purchase decision corresponds to a presented variation and indicates whether the customer has selected the corresponding variation for purchase. If so, the purchase decision is positive; if not, the purchase decision is negative. Vendor program 104 may receive zero or more positive purchase decisions and/or zero or more negative purchase decisions for the presented variations. In one embodiment, if vendor program 104 receives no purchase decision for a presented variation, vendor program 104 determines that the purchase decision for the presented variation is a negative purchase decision.

In step 218, vendor program 104 updates the customer record. In one embodiment, vendor program 104 appends the customer record with the presented datasets and the corresponding modifiers, prices, times of presentation, and purchase decisions.

FIG. 3 is a flowchart depicting operational steps of an aspect of the vendor program 104, in accordance with an embodiment of the present invention.

In step 302, vendor program 104 determines the amount of information gained by each variation of the customer record relative to the previously purchased datasets of the customer record. The amount of information gained may be measured in terms of, for example, number of records, number of attributes, precision of attributes, or amount of derived information. Derived information includes information which can be derived from the dataset or datasets in question, such as, for example, purchasing patterns derived by data-mining for frequent item sets. Vendor program 104 can compare a first variation to a second variation. Vendor program 104 can compare a first variation to a plurality of variations. For example, vendor program 104 may compare a first variation recommended at time t=3 to all variations recommended at time t<3 to determine the number of records contained in the first variation but not contained in any of the previously recommended variations. In one embodiment, vendor program 104 stores the information gain for a variation to the customer record to associate the information gain with the variation.

In step 304, vendor program 104 determines the value of a gain in information. In one embodiment, vendor program 104 determines the value of a gain in information for a customer by analyzing, for the variations of the customer record corresponding to the customer, the amounts of information gains, prices, and purchase decisions. In one embodiment, vendor program 104 utilizes a machine learning algorithm to determine the value of a gain in information. For example, vendor program 104 may utilize the machine learning algorithm with the determined information gain, prices, and purchase decision of each variation as inputs, wherein non-purchased variations are negative examples and purchased variations are positive examples.

In step 306, vendor program 104 determines the information gained for the variations generated in step 210. In one embodiment, vendor program 104 compares each generated variation to the variations of the customer record to determine an amount of information the generated variation gains over the previously presented variations. In another embodiment, vendor program 104 compares each generated variation to the variations of the customer record with a positive purchase decision to determine an amount of information the generated variation gains over the previously purchased variations. In one embodiment, the amount of information gained for a variation is the amount of information included in the variation which is not included in the variations to which it is being compared.

In step 308, vendor program 104 determines the value of the generated variations. In one embodiment, vendor program 104 computes the value of a generated variation based on the information gain of the generated variation and the value of a gain in information. In a simple example, vendor program 104 may determine the value of a generated variation by multiplying the amount of information gained by the dataset by the value of gaining information.

FIG. 4 depicts a block diagram of components of server computer 102 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computer 102 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Vendor program 104, customer database 108, and inventory database 110 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of client devices 114 and 116. In these examples, communications unit 410 includes one or more network interface cards. Communications unit 410 may provide communications through the use of either or both physical and wireless communications links. Vendor program 104, customer database 108, and inventory database 110 may be downloaded to persistent storage 408 through communications unit 410.

I/O interface(s) 412 allows for input and output of data with other devices that may be connected to server computer 102. For example, I/O interface(s) 412 may provide a connection to external devices 418 such as a keyboard, a keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., vendor program 104, customer database 108, and inventory database 110, can be stored on such portable computer-readable storage media and can be loaded onto persistent storage 408 via I/O interface(s) 412. I/O interface(s) 412 also connect to a display 420.

Display 420 provides a mechanism to display data to a user (e.g., a customer) and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
providing a set of datasets, including at least a first dataset, with each dataset of the set of datasets respectively being configured to allow the dataset to be presented according to multiple variations, with each variation being defined by a selection of at least one transformation;
receiving customer feedback information relating to at least a first variation of the first dataset;
training a first machine learning algorithm, based, at least in part, upon the customer feedback information; and
performing, by the first machine learning algorithm, a marketing act;
wherein:
the marketing act includes at least one of the following: (i) defining a new variation of the first dataset, (ii) defining a new transformation for defining variations of the first dataset, (iii) recommending a predefined variation of the first dataset, and (iv) pricing a predefined variation of the first dataset.

2. The method of claim 1 wherein:
the customer feedback information includes purchase and price information for a first customer; and
the marketing act includes at least one of the following: (i) defining a new variation of the first dataset for the first customer, (ii) recommending a predefined variation of the first dataset for the first customer, and (iii) pricing a predefined variation of the first dataset for the first customer.

3. The method of claim 2, further comprising:
training a second machine learning algorithm using the customer feedback information to determine a value of each transformation, wherein each dataset of the customer feedback information is associated with a time of presentation.

4. The method of claim 1, wherein:
the customer feedback information relates to the first dataset.

5. The method of claim 1, wherein:
the marketing act includes defining a new variation of the first dataset.

6. The method of claim 1, wherein:
the marketing act includes defining a new transformation for defining variations of the first dataset.

7. The method of claim 1, wherein:
the marketing act includes recommending a predefined variation of the first dataset.

8. The method of claim 1, wherein:
the marketing act includes pricing a predefined variation of the first dataset.
